(19) United States
(12) Patent Application Publication
(10) Pub. No.: US 2002/0139595 A1
(43) Pub. Date: Oct. 3, 2002

(54) Selectively bypassing skid steering function

(76) Inventor: David J. Whelan, Sag Harbor, NY (US)

Correspondence Address: Mr. Walter J. Tencza Jr., Suite 3, 10 Station Place, Metuchen, NJ, 08840, US

(21) Appl. No.: 09/948,363

(22) Filed: Sep. 7, 2001

Related U.S. Application Data
(60) Provisional application No. 60/281,212, filed on Apr. 3, 2001.

(51) Int. Cl. B62K 13/00

(52) U.S. Cl. 180/209; 180/21

(57) ABSTRACT

A combination of a skid steering type vehicle and a bypass device is disclosed. An operator can selectively raise one end of the skid steering type vehicle, slightly above the terrain and can functionally disengage one or two wheels of the skid steering type vehicle which are not capable of swiveling and engage one or more wheels of a bypass device which are capable of swiveling. In this manner a skid steering type vehicle in combination with the bypass device, can be turned in the manner of a typical passenger automobile, i.e. without dragging wheels along the ground surface.

### CLAIM FOR PRIORITY OF PROVISIONAL APPLICATION

This application claims the benefit and priority of Provisional application serial No. 60/281,212 filed on Apr. 3, 2001. The inventorship for this present application and the provisional application is the same.

### FIELD OF THE INVENTION

This invention relates to vehicles which normally steer by using skid steering or dragging techniques.

### BACKGROUND OF THE INVENTION

Vehicles of the prior art which steer by use of skid steering techniques have no ability to steer by means of swiveling, angling, or articulation, as for example a typical passenger automobile does. None of the wheels or tracks of the skid steering vehicles of the prior art can swivel with respect to the axis or body of the vehicle.

To provide a steering function on skid steering type vehicles, drive wheels or tracks are variously powered in forward or reverse or with respect to one another, thereby causing the skid steering type vehicle to turn by being dragged sideways over the terrain. Under many conditions the side-ways dragging causes damage to the terrain or ground surface and substantial wear to the tires and/or tracks of the skid steering vehicle.

### SUMMARY OF THE INVENTION

The present invention permits in one or more embodiments, an operator to selectively raise one end of a skid steering type vehicle, slightly above the terrain and to functionally disengage two wheels or a track end of the skid steering type vehicle, which are not capable of swiveling, and to engage one or more wheels of a bypass device which are capable of swiveling. In this manner the combination of the skid steering type vehicle and the bypass device can be turned in the manner of a typical passenger automobile, i.e. without dragging wheels or tracks along the ground surface.

The present invention can be used to adapt existing skid steering type vehicles such as skid-steer wheel and track vehicles. A single pivot-point supporting wheel or wheels can be provided in the bypass device. The wheel or wheels of the bypass device can be coupled to the non-load end or the load end of a skid steering type vehicle. The wheel or wheels can be connected to a wheel device which may be rotatably connected or hinged to the skid steering type vehicle such that the wheel device can be selectively raised or lowered by an operator.

The pivot point supporting wheel or wheels of the wheel device can be raised or lowered by force means of appropriate capacity to lift the end of the skid steering type vehicle off of the existing non-load or load wheels or track of the skid steering type vehicle and transfer that portion of the skid steering type vehicle's weight onto the single pivot-point supporting wheel or wheels of the bypass device. The force can be applied by hydraulic ram which can be affixed to the skid steering type vehicle and which when activated by the operator can lower a base plate for the swiveling wheel device of the bypass device. The force could be applied mechanically as well.

The pivot point supporting wheel or wheels is free to swivel freely in any direction as the existing steering function in the skid steering type vehicle is commanded by the operator. As a result, the combination of the bypass device and the skid steering type vehicle can variously turn in a) a sweeping arc as it travels, or b) it can actually spin on its own length without forward or reversed travel, thus enabling use in the tightest and most fragile areas. Wear on the tires or tracks and damage to the terrain are thereby eliminated or drastically reduced.

A further advantage is that a machine formerly limited to outdoor use can become a multipurpose machine for material handling in a warehouse setting, for instance. The elimination or reduction of terrain damage further permits the combination bypass device and skid steering type vehicle to operate on landscaped areas such as lawns, without tearing up the lawn.

The present invention in one or more embodiments provides an apparatus comprising a skid steering type vehicle comprised of a plurality of wheels and/ tracks and a bypass device. The bypass device allows an operator to steer the combination of the bypass device and the skid steering type vehicle without substantial dragging of any of the plurality of wheels or tracks of the skid steering type vehicle.

The bypass device may include a first wheel and a second wheel which are part of a wheel device. The bypass device can cause the first wheel and the second wheel of the bypass device to contact a ground surface and to bear at least part of the weight of the skid steering type vehicle, while first and second wheels of the skid steering type vehicle are not contacting the ground surface and are not bearing any weight of the skid steering type vehicle. The first and second wheels of the skid steering type vehicle should be located at the non-load end but may be also located at the load end in some cases. For instance where an attachment requires the load end to be elevated for efficient operation. The skid steering type vehicle includes a body portion which should be located between the first and second wheels of the skid steering type vehicle.

The wheel device of the bypass device may be rotatably connected to the skid steering type vehicle. The wheel device can be lifted off of and taken out of contact with the ground surface. The bypass device may be further comprised of a rod, having first and second ends, the first end of the rod being rotatably connected to the skid steering type vehicle and the second end of the rod being rotatably connected to the wheel device. The rod may be connected to a device which can raise or lower the rod and thereby raise or lower the wheel device of the bypass device. The device for raising or lowering the rod may be comprised of a motor, may be comprised of a hydraulic device, or may be any other known device for raising or lowering the rod.

The wheel device of the bypass device may include a plate, having first and second ends, the first end of the plate being rotatably connected to the skid steering type vehicle and the second end of the plate being rotatably connected to the second end of the rod. The wheels of the bypass device can swivel with respect to the plate of the wheel device.

The present invention in one or more embodiments also includes a method of first operating a skid steering type vehicle having a plurality of wheels so that one or more of the wheels are dragged in order to steer the skid steering type vehicle. Next, a first wheel and/or second wheel or track end of the skid steering device is lifted off of the ground surface and a first wheel of the bypass device is used to allow the combination of the bypass device and the skid steering type vehicle to be steered without dragging any of the plurality of wheels or track of the skid steering type vehicle and without dragging the first wheel of the bypass device.

### BRIEF DESCRIPTION OF THE DRAWINGS

FIG. 1 shows a left side view of an apparatus comprised of a skid steering type vehicle and a bypass device, wherein the bypass device is in a first state such that two tires of a wheel device of the bypass device are in contact with a ground surface and rear wheels of the skid steering type vehicle are not in contact with the ground surface;

FIG. 2 shows a left side view of the apparatus of FIG. 1 with the bypass device now placed in a transition state so that the two tires of the wheel device of the bypass device and the rear wheels of the skid steering type vehicle are all in contact with the ground surface;

FIG. 3 shows a left side view of the apparatus of FIG. 1 with the bypass device now placed in a second state so that two rear tires of the skid steering type vehicle are in contact with ground surface and the wheel device of the bypass device has been lifted off of the ground surface;

FIG. 4 shows a bottom view of the skid steering type vehicle and the bypass device of FIGS. 1-3 with the bypass device in the first state of FIG. 1.

FIG. 5 shows a left side view of an apparatus in accordance with another embodiment of the present invention where a bypass device has been added to the load end of a skid steering type vehicle;

### DETAILED DESCRIPTION OF THE DRAWINGS

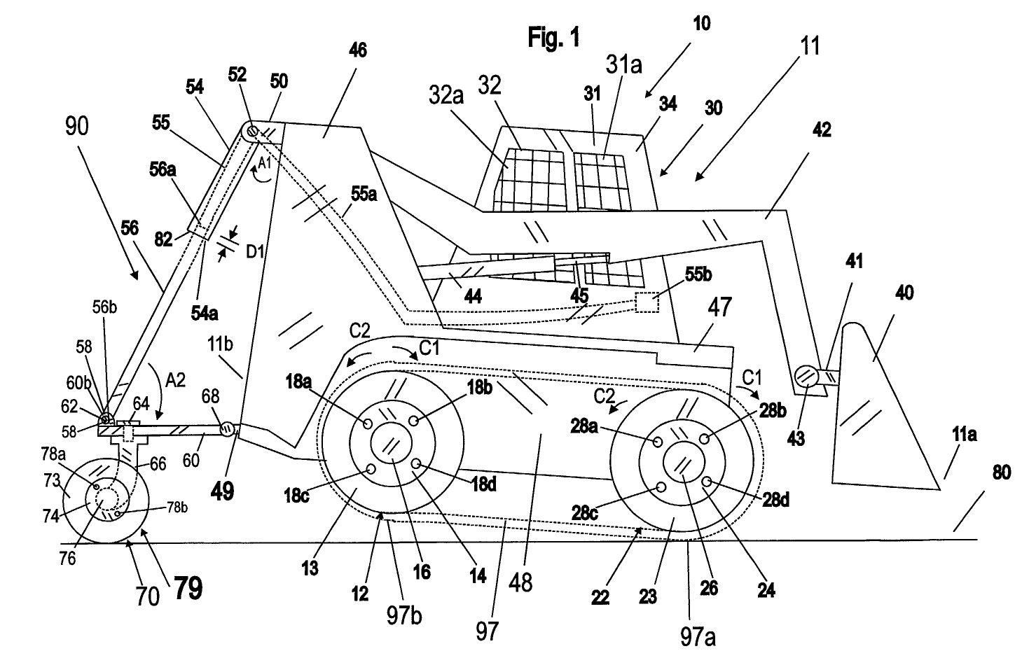

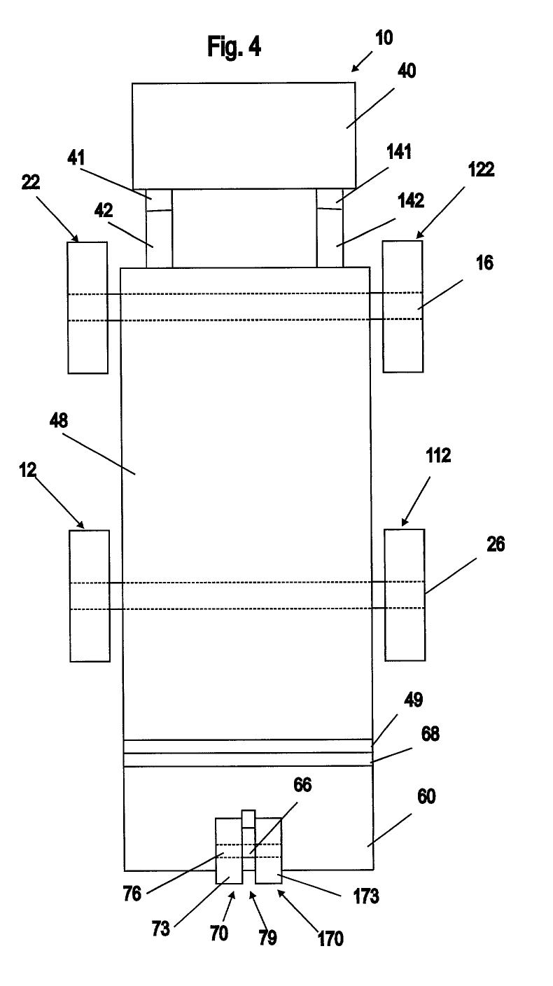

FIG. 1 shows a left side view of an apparatus 10 comprised of a skid steering type vehicle 11 and a bypass device 90, wherein the bypass device 90 is in a first state such that two tires 73 and 173 (shown in FIG. 4) of a wheel device 79 of the bypass device 90 are in contact with a ground surface 80. The skid steering type vehicle 11 has a load end 11a (with implement 40) and a non-load end 11b at the other end of the skid steering type vehicle 11. The right side view of the apparatus 10 in the first state of FIG. 1 is a mirror image of the left side view and for that reason the left side view is not shown.

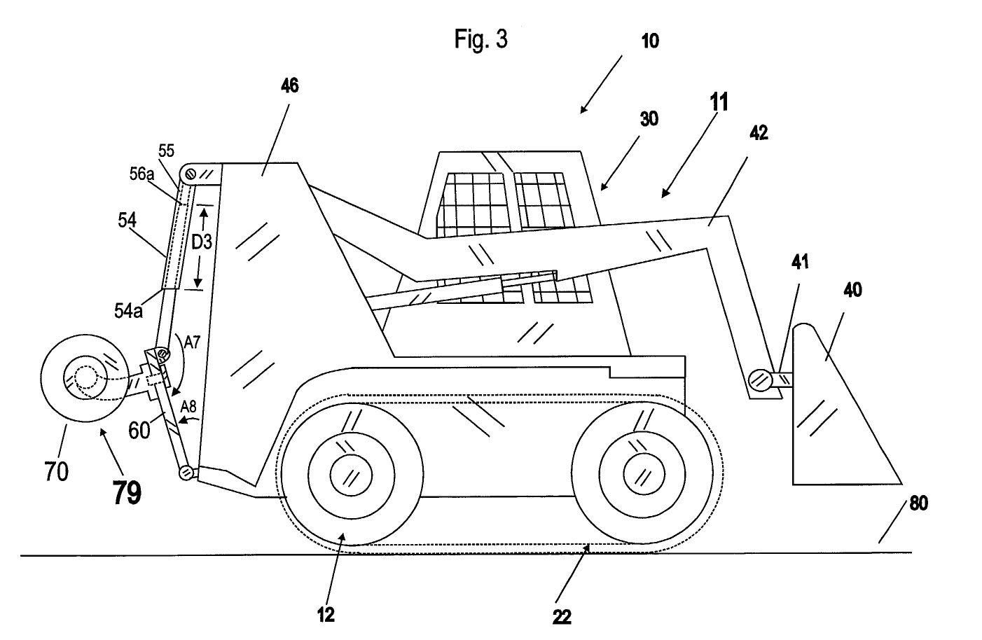

The skid steering type vehicle 11 may be a conventional bull dozer, tractor, BOBCAT (TRADEMARKED) or some other similar vehicle known in the art which steers by use of skid steering. “Skid steering” means that the wheels 12, 22, 112, and 122 (shown in FIG. 4) of the skid steering type vehicle 11 do not have the ability to swivel or turn. Turning of the skid steering type vehicle 11 (without the bypass device 90 being provided) is accomplished by causing a wheel or wheels on one side of the skid steering type vehicle 11 to be driven, while a wheel or wheels on the other side of skid steering device 11 are locked in place. For example, (referring to FIG. 3, where bypass device 90 is not being applied) wheels 12 and 22 on the left side of the skid steering type vehicle 11 can be driven, while wheels 112 and 122 on the right side of the skid steering type vehicle 11 can be locked in place. The skid steering type vehicle 11, in this example would turn, with the wheels 112 and 122 being dragged along a ground surface.

The skid steering type vehicle 11 includes rear wheel 12 and front wheel 22 shown in FIG. 1 and a rear wheel 112 and a front wheel 122 shown in FIG. 4. Rear wheel 12 is comprised of tire 13 and rim 14 shown in FIG. 1. Rear wheel 112 is identical to rear wheel 12. Rear wheel 12 and rear wheel 112 are connected to an axle 16 in a manner known in the art, such as for example by lug nuts, ball bearings, and other devices. Wheel 12 may be connected to axle 16 by lug nuts 18a-d. Rear wheel 12 and rear wheel 112 may rotate in a clockwise direction C1 or in a counterclockwise direction C2, either on the axle 16 or together with the axle 16. Rear wheels 12 and 112 cannot swivel and always point in the same direction with respect to a body portion 48 of the skid steering type vehicle 11.

The skid steering type vehicle 11 may include optional belt or track 97 shown in dashed lines in FIG. 1 and an opposing similar belt or track 197 shown in dashed lines in FIG. 4. The tracks 97 and 197 may come in contact with the ground surface 80 and be between the wheels 12 and 22 (for track 97) and 112 and 122 (for track 197) and the ground surface 80. In that case the wheels 12, 22, 112, and 122 would not actually contact the surface 80. However, the operation of the present invention in various embodiments permits the weight to be taken off of the wheels 12 and 112 by bypass device 90 regardless of whether there are tracks 97 and 197 or not. It is possible that the tracks 97 and 197 might be provided and the wheels 12, 22, 112, and 122 not provided and in that case bypass device 90 can be engaged so that bypass device 90 takes part of the weight of vehicle 11 so that portion 97b (at a certain instant of time) of the track 97 does not contact the ground surface 80.

Similarly front wheel 22 is comprised of tire 23 and rim 24. Front wheel 122, shown in FIG. 4, is identical to front wheel 22. Front wheels 22 and wheel 122 are connected to axle 26 in a manner known in the art, such as for example by lug nuts, ball bearings, and other devices. Front wheel 22 may be connected to axle 26 by lug nuts 28a-d. Front wheels 22 and 122 may rotate in a clockwise direction C1 or in a counterclockwise direction C2. Front wheels 22 and 122 cannot swivel and always point in the same direction with respect to a body portion 48 of the skid steering type vehicle 11.

The skid steering type vehicle 11 includes a cab 30, body portions 46, 47, and 48, arms 42 and 142 (shown by FIG. 4), arm 44 and rod 45, extension 41 and hinge 43, and implement or shoveling device 40. The cab 30 is an area where an operator sits when driving the skid steering device 11. The cab 30 includes windows 31 and 32 covered with nets or screens 31a and 32a, respectively. The cab 30 also includes portion 34. The cab 30 encloses an open chamber in which an operator can sit to operate the skip steering type vehicle 11 and the bypass device 90. Portion 34 of the cab 30 is fixed to body portion 47 which is fixed to body portions 46 and 48. The axles 16 and 26 are connected to body portion 48 so that either the wheels 12, 22, 112, and 122 can rotate on the axles 16 and 26 or with the axles. However, the axles 16 and 26 are connected to the body portion 48 in a manner so that the axles 16 and 26, and the wheels 12, 22, 112, and 122 cannot swivel with respect to the body portion 48. I.e. when all four wheels 12, 22, 112, and 122 are driven with the same power (in a four wheel drive scenario) the skid steering type vehicle 11 cannot turn.

The bypass device 90, as shown in FIG. 1, in accordance with an embodiment of the present invention, is comprised of extensions 49 and 50, which are fixed to the skid steering device 11. The bypass device 90 is also comprised of a tube 54 which is rotatably connected to the extension 50 by a pin 52 and a plate 60 which is rotatably connected to the extension 49 by a hinge 68. The bypass device 90 is also comprised of a rod 56 which is connected by a device 55 for raising and lowering the rod 56, such as a motor or hydraulic device or other device known in the art, to tube 54. The device 55, can pull the rod 56 up into the tube 54 until the rod 56 contacts the pin 52. The device 55, can also push the rod 56 down towards an end 54a of the tube 54, until just before the rod 56 reaches the end 54a. A stop 82 may prevent the rod 56 from completely leaving the tube 54. The device 55 is shown connected by a conductor 55a to a control device 55b, shown by dashed lines in FIG. 1, which may be located in the cab 30 of the skid steering type vehicle 11. The bypass device 90 will also be described as including the control device 55b and the conductor 55a even if these are at least somewhat physically located on or near the skid steering type vehicle 11.

The bypass device 90 may also be comprised of an extension 62 fixed to the plate 60 and rotatably connected to the rod 56 at an end 56b by a pin 58. The bypass device 90 may also include a wheel device 79. The wheel device 79 may include a pin 64, an extension 66 which may be in the shape of a J (partially shown by dashed lines in FIG. 1), wheels 70 and 170 (shown by FIG. 4) and an axle 76. The wheel device 79 may be rotatably connected to the plate 60 by pin 64 so that the wheel device 79 can swivel with respect to the plate 60 and with respect to the body portion 48 of the skid steering type vehicle 11. The wheel 70 may include a tire 73 and a rim 74. The wheel 170 may be identical to the wheel 70. The wheel 70 may be connected to the axle 76 by lug nuts 78a and 78b or in some other known manner. The wheels 70 and 170 may rotate on the axle 76 or may rotate with the axle 76 in a clockwise direction C1 or in a counterclockwise direction C2. The J-shaped extension 66 can rotate with respect to the plate 60 about the axis of the pin 64, which allows the wheel device 79 to swivel.

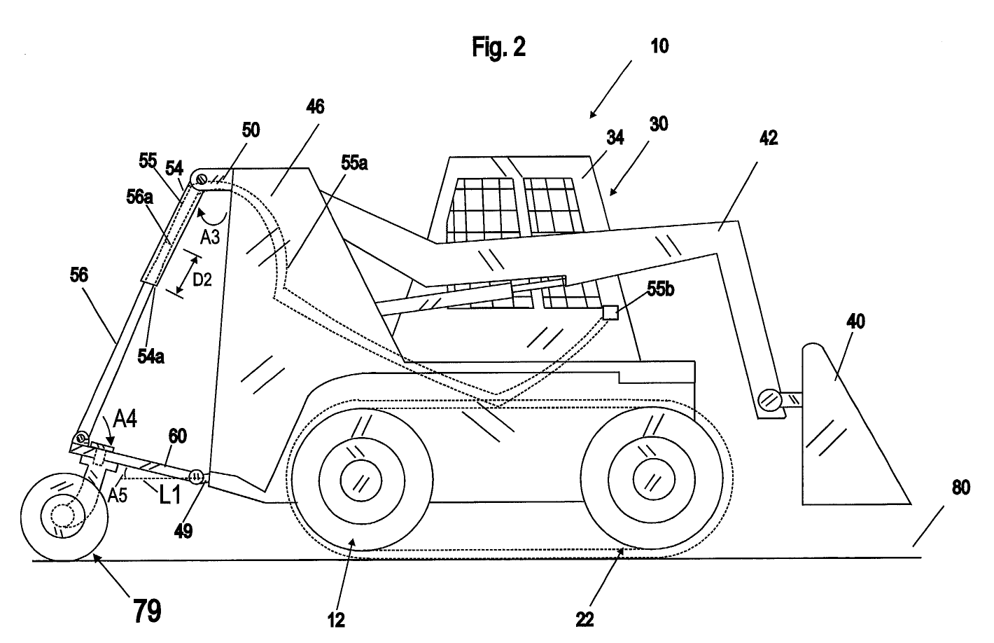

In operation with reference to FIGS. 1-3, an operator riding in cab 30 can use control device 55b to place the bypass device 90 into either a first state or a second state. FIG. 2 shows a transition state between these two states. In the first state, shown in FIG. 1, the wheels 70 and 170 of the wheel device 79 and the wheels 22 and 122 of the skid steering type vehicle 11 all contact the ground surface 80. However, the rear wheels 12 and 112 of the skid steering type vehicle 11 do not contact the ground surface 80 in the first state of FIG. 1. Thus, the weight of the vehicle 11 rests on wheel device 79 and front wheels 22 and 122 and the weight of the vehicle 11 does not rest on the rear wheels 12 and 112. The tube 54 is at an angle of A1 with respect to the body portion 46 and the rod 56 is at an angle of A2 with respect to the plate 60. The length of a portion of the rod 56 within the tube 54 is equal to distance D1 from the end 54a of the tube 54 to the end 56a of the rod 56.

In a transition state, shown in FIG. 2, the wheels 70 and 170, as well as wheels 22 and 122, continue to contact the ground surface 80, however, the wheels 12 and 112 now also contact the ground surface 80. Thus the wheels 70, 170, 12, 112, 22, and 122 all bear the weight of the vehicle 11. In the transition state of FIG. 2, the rod 56 has gone further into the tube 54 so that the distance D2 between the end 56a of the rod 56 and end 54a of the tube 54 is greater than the distance D1 in FIG. 1. The tube 54 has rotated with respect to the body portion 46 and the angle between the tube 54 and the body portion 46 is now A3 which is greater than the angle A1 for the first state in FIG. 1. The rod 56 has also rotated with respect to the plate 60, and the angle between the rod 56 and the plate 60 is now A4 which is greater than the angle A2 in the first state of FIG. 1. An angle A5 has also been created between the plate 60 and a line L1 going through the extension 49, whereas in FIG. 1 the angle between plate 60 and the extension 49 was zero. The right side view of the apparatus 10 in the transition state of FIG. 2 is a mirror image of the left side view and for that reason the right side view is not shown.

In the second state, shown in FIG. 3, the wheels 70 and 170 of the wheel device 79 do not contact the ground surface 80 and do not bear the weight of the vehicle 11. The wheels 12, 112, 22, and 122 all contact the ground surface 80 and the wheels 12, 112, 22, and 122 bear the weight of the skid steering type vehicle 11. The rod 56 has gone further into the tube 54 so that the distance D3 between the end 56a of the rod 56 and the end 54a of the tube 54 is more than the distance D2 in FIG. 2. The tube 54 has rotated with respect to the body portion 46 and the angle between the tube 54 and the body portion 46 is now A6, which is less than the angle A1 for the first state in FIG. 1. The rod 56 has also rotated with respect to the plate 60, and the angle between the rod 56 and the plate 60 is now A7 which is greater than the angle A4 in the transition state of FIG. 2. An angle A8 also exists between the body portion 46 and the plate 60. The right side view of the apparatus 10 in the second state of FIG. 3 is a mirror image of the left side view and for that reason the right side view is not shown.

The skid steering type vehicle 11 and the bypass device 90 may start out in the second state of FIG. 3. An operator may use control device 55b to place the combination of the skid steering type vehicle 11 and the bypass device 90 into the first state of FIG. 1. The operator may activate a switch on control device 55b which may send a signal through conductor 55a which may cause the device 55 in tube 54 to push down and out on the rod 56 so that the rod 56 is moved from its position in FIG. 3 continuously to a transition position in FIG. 2 and then continuously to the position shown in FIG. 1. This causes the wheel device 79 to gradually come in contact with the ground surface 80, as shown in FIG. 2, and then causes the wheels 12 and 112 to be raised off of the ground surface 80, while the wheel device 79 takes over the weight bearing of the rear of vehicle 11 and bypass device 90.

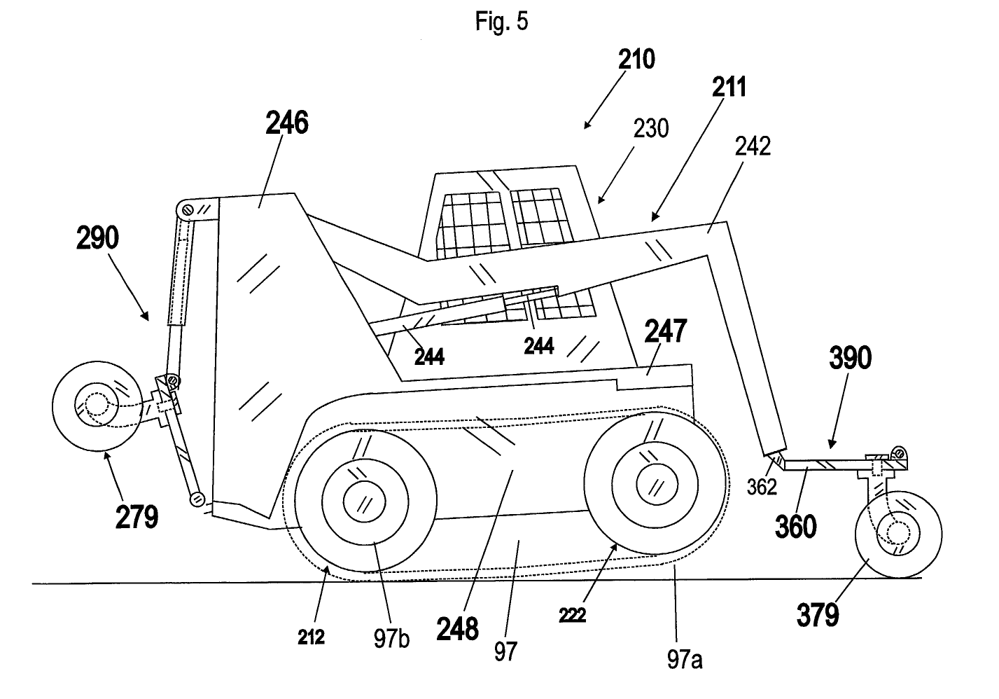

The operator may activate another switch on control device 55b which may send a signal through conductor 55a which may cause the device 55 in tube 54 to pull up on the rod 56 so that the rod 56 is moved from its position in FIG. 1 (bypass device 90 engaged and wheel device 79 bearing weight) continously to its position in FIG. 2 (transition state) and into continously to its position in FIG. 3 (bypass device 90 disengaged and not bearing weight) FIG. 5 shows a left side view of an apparatus 210 in accordance with another embodiment of the present invention where a bypass device 390 has been added to the load end of a skid steering type vehicle 211. A bypass device 290 is also shown connected to the non-load end of the skid steering type vehicle 211. The bypass device 290 may be the same as bypass device 90 of FIG. 1 and include wheel device 279 similar to wheel device 79. The skid steering type vehicle 211 may be the substantially the same as the skid steering type vehicle 11 of FIGS. 1-4 and may include wheels 212, 222, cab 230, arm 242, arm 244, rod 245, body portions 246, 247, and 249 similar to similarly numbered components for skid steering type vehicle 11 of FIGS. 1-4.

The bypass device 390 at the load end of the apparatus 210 of FIG. 5 may include a wheel device 379 similar to wheel devices 79 and 279. The bypass device 390 may include a plate 360 similar to plate 60 of FIG. 1. However the plate 360 may be fixed by member 362 to arm 242 rather than hinged as wheel devices 79 and 279 are. The bypass device 390 may be operated by using the load arm 242 to push down on the plate 360 causing the front wheel 222 (and its opposing front wheel similar to front wheel 122 of FIG. 4) to lift off of the ground surface 380 as shown in FIG. 5. The load arm 242 may also pull up on the plate 360 in which case the front wheel 222 (and its opposing front wheel similar to front wheel 122 of FIG. 4), to contact the ground surface 380. The load arm 242 may continue to pull up on the plate 360 which would cause the wheel device 379 to no longer contact the ground surface 380. In this manner, the vehicle 211 with the bypass device 390 can be driven either (1) with the wheels 212 and 222 (and their corresponding opposing wheels like wheels 112 and 122 of FIG. 4) on the ground surface 380 and with the wheel device 379 off the ground or (2) with the wheel 212 (and its corresponding opposing wheel like 112) and the bypass device 379 on the ground surface 380 and the wheel 222 and (and its corresponding opposing wheel like wheel 122) lifted off the ground and not bearing weight.

The present invention in one or more embodiments allows skid steering type vehicles such as certain tractors to selectively operate in a non skid steering mode when used in combination with a bypass device, such as bypass devices 90, 290 and 390.

I claim:

1. An apparatus comprising:
a skid steering type vehicle comprised of a plurality of wheels; and
a bypass device;
wherein the bypass device allows an operator to steer the combination of the skid steering type vehicle and the bypass device without substantial dragging of any of the wheels of the skid steering type vehicle.

2. The apparatus of claim 1 wherein:
the bypass device includes a first wheel which is part of a wheel device;
the plurality of wheels of the skid steering type vehicle includes a first wheel;
the bypass device can cause the first wheel of the bypass device to contact a ground surface and to bear at least part of the weight of the skid steering type vehicle, while the first wheel of the skid steering type vehicle is not bearing any weight of the skid steering type vehicle.

3. The apparatus of claim 2 wherein:
the plurality of wheels of the skid steering type vehicle includes a second wheel and a body portion wherein the body portion of the skid steering type vehicle is located between the first wheel and the second wheel of the skid steering type vehicle;
the bypass device can cause the first wheel of the bypass device to contact a ground surface and to bear at least part of the weight of the skid steering type vehicle, while the first and the second wheel of the skid steering type vehicle are not bearing any weight of the skid steering type vehicle.

4. The apparatus of claim 2 wherein:
the wheel device of the bypass device is rotatably connected to the skid steering type vehicle.

5. The apparatus of claim 4 wherein:
the first wheel of the bypass device is part of a wheel device which is connected by a hinge to the skid steering type vehicle;
and the wheel device can be lifted off of and taken out of contact with the ground surface.

6. The apparatus of claim 2 wherein
the bypass device is further comprised of a rod, having first and second ends, the first end of the rod being rotatably connected to the skid steering type vehicle and the second end of the rod being rotatably connected to the wheel device.

7. The apparatus of claim 6 wherein
the rod is connected to a device which can raise or lower the rod and thereby raise or lower the wheel device of the bypass device.

8. The apparatus of claim 7 wherein
the device which can raise or lower the rod uses hydraulics.

9. The apparatus of claim 7 wherein:
the wheel device of the bypass device includes a plate, having first and second ends, the first end of the plate being rotatably connected to the skid steering type vehicle and the second end of the plate being rotatably connected to the second end of the rod;
wherein the first wheel of the bypass device can swivel with respect to the plate of the wheel device of the bypass device.

10. The apparatus of claim 2 wherein:
the bypass device includes a second wheel which is part of a wheel device;
the plurality of wheels of the skid steering type vehicle includes a second wheel;
the bypass device can cause the first wheel and the second wheel of the bypass device to contact a ground surface and to bear at least part of the weight of the skid steering type vehicle, while the first wheel and the second wheel of the skid steering type vehicle are not bearing any weight of the skid steering type vehicle.

11. The apparatus of claim 1 wherein:
the skid steering type vehicle includes a load end and a non-load end;
wherein the bypass device is connected to the skid steering type vehicle at the non-load end.

12. A method comprising the steps of:
operating a skid steering type vehicle having a plurality of wheels so that one or more of the wheels are dragged in order to steer the skid steering type vehicle;
lifting up a first wheel of the skid steering type vehicle and using a first wheel of a bypass device to allow the combination of the bypass device and the skid steering type vehicle to be steered without dragging any of the plurality of wheels of the skid steering type vehicle and without dragging the first wheel of the bypass device.

13. The method of claim 12 further comprising
lifting up a second wheel of the skid steering type vehicle wherein the skid steering type vehicle includes a body portion and wherein the body portion is located between the first wheel and the second wheel of the skid steering type vehicle.

14. The method of claim 13 wherein
the first and second wheel of the skid steering type vehicle are located at a non-load end of the skid steering type vehicle.

15. The method of claim 12 further comprising the steps of
lowering the first and second wheels of the skid steering type vehicle so that can the skid steering type vehicle can be steered only by dragging one or more of the plurality of wheels of the skid steering type vehicle;
and lifting up the first wheel of the bypass device so that the first wheel of the bypass device does not bear any weight of the skid steering type vehicle.

16. The method of claim 12 wherein:
the first wheel of the bypass device is part of a wheel device which is rotatably connected to the skid steering type vehicle;
and the wheel device can be lifted off of and taken out of contact with the ground surface.

17. The method of claim 16 wherein
the bypass device is further comprised of a rod, having first and second ends, the first end of the rod being rotatably connected to the skid steering type vehicle and the second end of the rod being rotatably connected to the wheel device.

18. The method of claim 17 wherein
the rod is connected to a device which can raise or lower the rod and thereby raise or lower the wheel device of the bypass device.

19. The method of claim 18 wherein:
the wheel device of the bypass device includes a plate, having first and second ends, the first end of the plate being rotatably connected to the skid steering type vehicle and the second end of the plate being rotatably connected to the second end of the rod;
wherein the first wheel of the bypass device can swivel with respect to the plate of the wheel device of the bypass device.

20. An apparatus comprising:
a skid steering type vehicle comprised of a plurality of tracks; and
a bypass device;
wherein the bypass device allows an operator to steer the combination of the skid steering type vehicle and the bypass device without substantial dragging of any of the tracks of the skid steering type vehicle.
